(19) United States
(12) Patent Application Publication
(10) Pub. No.: US 2007/0058255 A1
(43) Pub. Date: Mar. 15, 2007

(54) Optical scanner and image forming apparatus

(76) Inventors: Shigeaki Imai, Kanagawa (JP); Tomohiro Nakajima, Tokyo (JP); Yoshinori Hayashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/508,881

(22) Filed: Aug. 24, 2006

(30) Foreign Application Priority Data
Sep. 9, 2005 (JP) 2005-262365

(51) Int. Cl. G02B 5/18

(52) U.S. Cl. 359/566

(57) ABSTRACT

An optical scanner includes a light source; a deflecting unit that deflects and scans a light beam emitted from the light source; a scanning optical system that focuses the light beam deflected and scanned onto different surfaces to be scanned; and a light quantity correcting unit that corrects a light quantity of the light beam. The light quantity correcting unit changes light quantity correction data used for correcting the light quantity of the light beam for each of the surfaces. The light quantity correction data is dependent on positions in a main scanning direction.

### BACKGROUND OF THE INVENTION

1. Field of the Invention

The present invention relates to an optical scanner and an image forming apparatus such as a copier, a printer, a facsimile machine, and a plotter including the same.

2. Description of the Related Art

Electrophotographic image forming apparatuses such as laser printers, digital copiers, and plain paper facsimile machines for creating color documents at high speed are becoming increasingly widespread, and tandem type image forming apparatuses including a plurality of (typically four) photoconductors are becoming popular.

There are color electrophotographic image forming apparatuses that only include one photoconductor, which is rotated corresponding to the number of colors. However, these apparatuses have a disadvantage in terms of productivity. Specifically, if there are four colors and only one photoconductive drum, the photoconductor needs to be rotated four times.

However, a tandem type image forming apparatus requires more light sources. Accordingly, the number of components increases, color shifts are caused by differences in wavelengths among the plurality of light sources, and the cost increases. Further, deterioration of semiconductor lasers cause failures in the writing unit. When there are many light sources, failures are more likely to occur, and the service life of the apparatus is shortened.

In view of these problems, Patent Document 1 discloses an optical scanning method as follows. A light beam from a single light source is divided, and the divided light beams are guided to a polygon scanner including polygon mirrors disposed in different levels. As the polygon mirrors disposed at different levels have rotational angles different from each other in the main scanning direction, a light beam from a single light source is made to scan a surface on a time-division manner. Accordingly, images can be output at high speed even with a reduced number of light sources.

Patent Document 2 discloses a technology for scanning different surfaces with a light beam from a common light source by using a pyramidal mirror or a plane mirror. In this case, the number of light sources can be reduced; however, the maximum number of surfaces of a deflection mirror is two. Thus, a sufficiently high speed cannot be attained.

Patent Document 3 discloses a technology for providing an angular difference between two levels of polygon mirrors in a deflecting rotational surface in order to increase the scan width.

Patent Documents 4 and 5 disclose a technology of principally changing the frequency of a pixel clock in order to correct uneven intervals between beam spot positions.

Patent Documents 6 and 7 disclose a technology of changing the phase of a pixel clock in order to correct uneven intervals between beam spot positions.

Patent Document 1: Japanese Laid-Open Patent Application No. 2005-92129

Patent Document 2: Japanese Laid-Open Patent Application No. 2002-23085

Patent Document 3: Japanese Laid-Open Patent Application No. 2001-83452

Patent Document 4: Japanese Laid-Open Patent Application No. H11-167081

Patent Document 5: Japanese Laid-Open Patent Application No. 2001-228415

Patent Document 6: Japanese Laid-Open Patent Application No. 2003-098465

Patent Document 7: Japanese Laid-Open Patent Application No. 2004-098590

However, in the optical scanning method disclosed in Patent Document 1, a plurality of divided light beams are guided to different surfaces by passing through different optical elements (scanning lens, light path bending mirror, etc.). Accordingly, the following problems occur.
(1) Shading properties, i.e., variations in the light beam intensity according to the main scanning position on the surface are different among a plurality of surfaces. Therefore, color irregularities are caused.
(2) Shifts of beam spot positions in the main scanning direction, which are caused by optical elements, are different among a plurality of surfaces. Therefore, color shifts occur.

In the above-described methods of correcting shading properties and shifts of beam spot positions, a single light source is shared by a plurality of surfaces to be scanned. Accordingly, shading properties and shifts of beam spot positions can be corrected for one surface, but not for another surface. In the worst case, the shading properties and shifts of beam spot positions on a surface become even worse than before making the correction.

### SUMMARY OF THE INVENTION

Accordingly, the present invention may provide an optical scanner and an image forming apparatus including the same in which the above-described disadvantage is eliminated.

A preferred embodiment of the present invention provides an optical scanner and an image forming apparatus including the same that can appropriately correct color irregularities and color shifts, and output images at high speed, even with a reduced number of light sources.

An embodiment of the present invention provides an optical scanner including a light source configured to emit a light beam; a deflecting unit configured to deflect and scan the light beam emitted from the light source; a scanning optical system configured to focus the light beam deflected and scanned by the deflecting unit onto a plurality of different surfaces to be scanned; and a light quantity correcting unit configured to correct a light quantity of the light beam emitted from the light source; wherein the light quantity correcting unit changes light quantity correction data used for correcting the light quantity of the light beam emitted from the light source for each of the different surfaces to be scanned, the light quantity correction data being dependent on positions in a main scanning direction.

An embodiment of the present invention provides an optical scanner including a light source configured to emit a light beam; a deflecting unit configured to deflect and scan the light beam emitted from the light source; a scanning optical system configured to focus the light beam deflected and scanned by the deflecting unit onto a plurality of different surfaces to be scanned; and a beam spot position correcting unit configured to correct beam spot positions in a main scanning direction on each of the different surfaces to be scanned; wherein the beam spot position correcting unit changes position correction data used for correcting the beam spot positions for each of the different surfaces to be scanned.

According to one embodiment of the present invention, an optical scanner and an image forming apparatus including the same can output images at high speed, and appropriately reduce color irregularities and color shifts without adversely affecting the images, even with a reduced number of light sources. Further, as the number of light sources can be reduced, the overall failure rate of the unit can be reduced, so that a long service life can be achieved. Moreover, a light beam emitted from a common light source is divided into a plurality of light beams, and each of the light beams scans a different surface. Thus, differences in qualities of light beams are reduced, so that high-quality images can be achieved.

Further, the amount of light quantity correction data or position correction data can be reduced, and therefore, the capacity of a storage unit such as a memory can be reduced. Accordingly, the circuit can be made compact and costs can be reduced.

### BRIEF DESCRIPTION OF THE DRAWINGS

Other objects, features and advantages of the present invention will become more apparent from the following detailed description when read in conjunction with the accompanying drawings, in which:

FIG. 1 is a partially omitted perspective view of an optical scanner according to a first embodiment of the present invention;

FIG. 2 is a schematic diagram of functions of a light flux dividing unit;

FIGS. 3A, 3B are schematic diagrams for describing an operation of blocking some light beams among a plurality of light beams emitted from a common light source;

FIGS. 4A, 4B, 4C provide time charts of lights exposed from a common light source; FIG. 4A illustrates full lighting, FIG. 4B illustrates light quantity correction data being switched for different surfaces to be scanned, and FIG. 4C illustrates preset light quantities being switched for different surfaces to be scanned;

FIG. 5 is a schematic diagram of a relationship between positions of synchronous accepting units and an effective scan width;

FIGS. 6A, 6B describe a method of correcting light quantities according to shading properties; FIG. 6A is a chart of shading properties, and FIG. 6B is a chart of light quantity correction amounts;

FIG. 7 is a block diagram for describing data control;

FIGS. 8A, 8B provide aberration diagrams of light sources;

FIG. 9 provides a time chart of a correction operation using position correction data according to a second embodiment of the present invention;

FIG. 10 provides time charts of switching image write start timings for different surfaces to be scanned according to a third embodiment of the present invention;

FIG. 11 provides time charts of switching clock frequencies of a light source for different surfaces to be scanned according to a fourth embodiment of the present invention;

FIGS. 12A, 12B, 12C are schematic diagrams and charts describing beam spot positions according to a fifth embodiment of the present invention;

FIG. 13 is a chart describing shifts of beam spot positions before and after correction;

FIG. 14 is a block diagram of a configuration for changing a period of a pixel clock according to a sixth embodiment of the present invention;

FIGS. 15A, 15B, 15C are charts describing the principle of changing a period of a pixel clock;

FIG. 16 is a chart describing the principle of changing a period of a pixel clock;

FIGS. 17A, 17B, 17C are schematic diagrams and charts describing shifted phases of a pixel clock;

FIGS. 18A, 18B are charts describing. the operation of changing frequencies of a pixel clock by each section according to a seventh embodiment of the present invention;

FIG. 19 provides timing charts of rewriting light quantity correction data or position correction data according to an eighth embodiment of the present invention;

FIG. 20 is a schematic diagram of a tandem type multicolor image forming apparatus according to an eleventh embodiment of the present invention;

FIG. 21 is a perspective view of a cylindrical lens fixed to a middle member, describing positional adjustments of an optical element (cylindrical lens) between a light flux dividing unit and a deflecting unit;

FIG. 22 is a perspective view of a middle member fixed to a housing of the optical scanner, describing positional adjustments of an optical element (cylindrical lens) between a light flux dividing unit and a deflecting unit;

FIG. 23 is another example of a perspective view of a cylindrical lens fixed to a middle member, describing positional adjustments of an optical element (cylindrical lens) between a light flux dividing unit and a deflecting unit; and

FIG. 24 is another example of a perspective view of a middle member fixed to a housing of the optical scanner, describing positional adjustments of an optical element (cylindrical lens) between a light flux dividing unit and a deflecting unit.

### DETAILED DESCRIPTION OF THE PREFERRED EMBODIMENTS

A description is given, with reference to the accompanying drawings, of an embodiment of the present invention.

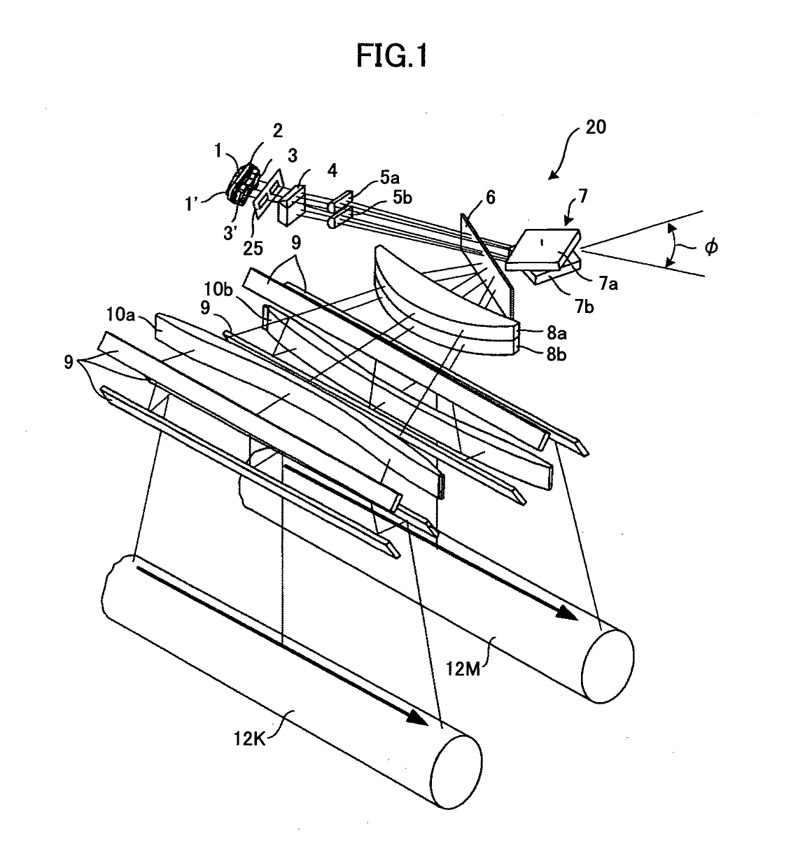

FIG. 1 is a partially omitted perspective view of an optical scanner 20 according to a first embodiment of the present invention.

First, a summary of the configuration and functions of the optical scanner 20 according to the first embodiment is described with reference to FIG. 1. In FIG. 1, reference numerals 1, 1′ denote semiconductor lasers functioning as light sources, 2 denotes a support base (LD base) of the semiconductor lasers, 3, 3′ denote coupling lenses, 4 denotes a half mirror prism functioning as a light flux dividing unit, 5a, 5b denote cylindrical lenses, 6 denotes a noise insulating glass, 7 denotes a deflecting unit including an upper polygon mirror 7a and a lower polygon mirror 7b functioning as reflection polygon mirrors, 8a, 8b denote first scanning lenses of an optical scanning system, 9 denotes mirrors in the optical scanning system, 10a, 10b denote second scanning lenses in the optical scanning system, 12K, 12M denote photoconductors that are subject to scanning, and 25 denotes an aperture.

The semiconductor lasers 1, 1′, the support base 2, and the coupling lenses 3, 3′ are integrally assembled, forming a light source unit.

The configuration of the optical system shown in FIG. 1 includes only two photoconductors. However, in reality, another identical optical system is provided on the other side of the deflecting unit 7, so that a total of four photoconductors are subject to scanning.

A diffused light flux emitted from the semiconductor lasers 1, 1′ is converted to a weak converged light flux or a parallel light flux or a weak diffused light flux by the coupling lenses 3, 3′.

Light beams output from the coupling lenses 3, 3′ pass through the aperture 25, and then enter the half mirror prism 4. A light beam from a single light source is divided into an upper level and a lower level at the half mirror prism 4, so that a total of four light beams are emitted from the half mirror prism 4.

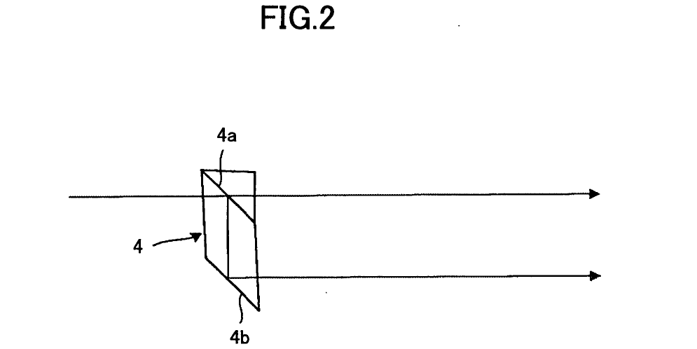

FIG. 2 is a cross-sectional schematic diagram of the half mirror prism 4 taken along the sub-scanning direction. Reference numeral 4a denotes a half mirror, which separates a transmission light and a reflection light by a ratio of 1:1. Reference numeral 4b denotes a total reflection surface, which has a function of converting the direction of a light beam.

In this example, the half mirror prism 4 is employed as the light flux dividing unit; however, a similar optical system can be formed by combining a half mirror with a regular mirror. Nevertheless, a half mirror prism can minimize loss of light quantity, and is therefore the optimal light flux dividing unit for the present invention. Further, the separation ratio of the half mirror need not be 1:1, but can be any ratio according to conditions of other optical systems.

Light beams output from the half mirror prism 4 are converted into long line images in the main scanning direction near the deflecting reflection surfaces of the deflecting unit 7 by the cylindrical lenses 5a, 5b provided on an upper level and a lower level, respectively. The upper polygon mirror 7a and the lower polygon mirror 7b of the deflecting unit 7 provided at the upper level and the lower level, respectively, are shifted from each other by an angle φ.

In this example, the upper polygon mirror 7a and the lower polygon mirror 7b, each including four surfaces, are shifted from each other by φ=45 degrees. The upper polygon mirror 7a and the lower polygon mirror 7b can be formed integrally, or assembled as separate parts.

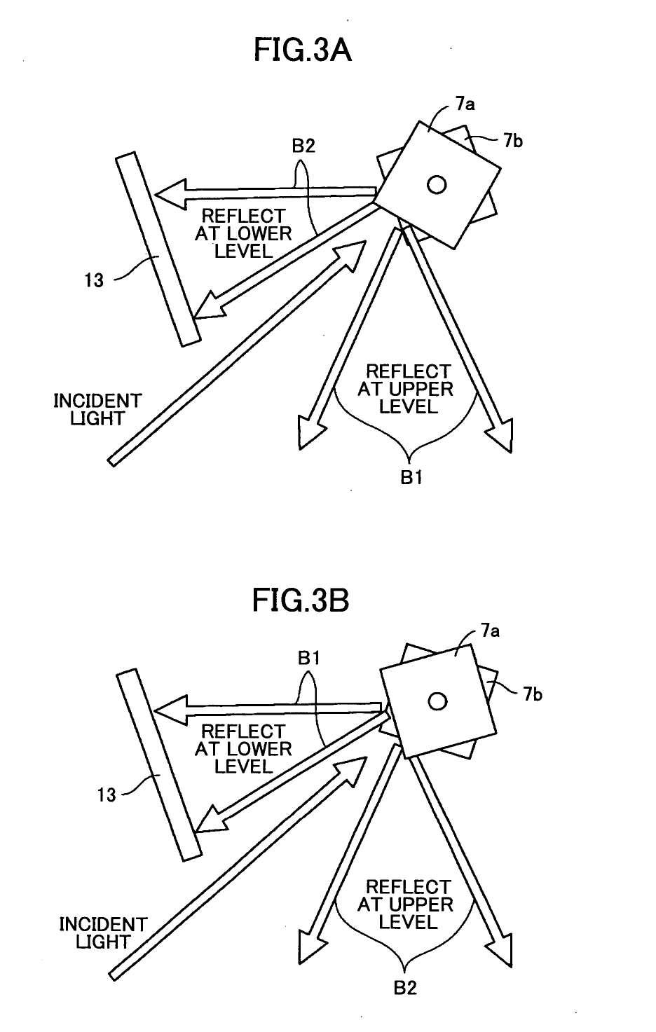

As shown in FIG. 3A, when light beams B1 of the upper level from a common light source are scanning a photoconductor surface (surface subject to scanning), the light beams B2 of the lower level are prevented from reaching the photoconductor surface, preferably blocked with a blocking member 13.

As shown in FIG. 3B, when the light beams B2 of the lower level from a common light source are scanning a photoconductor surface (surface subject to scanning), which is different from the photoconductor surface scanned by the light beams B1 of the upper level, the light beams B1 of the upper level are prevented from reaching the photoconductor surface being scanned by the light beams B2 of the lower level. Further, the light beams B1 of the upper level and the light beams B2 of the lower level are modulated at different timings. Specifically, when scanning the photoconductor corresponding to the upper level, the light source is modulated on the basis of image information of a color corresponding to the upper level (for example, black). When scanning the photoconductor corresponding to the lower level, the light source is modulated on the basis of image information of a color corresponding to the lower level (for example, magenta).

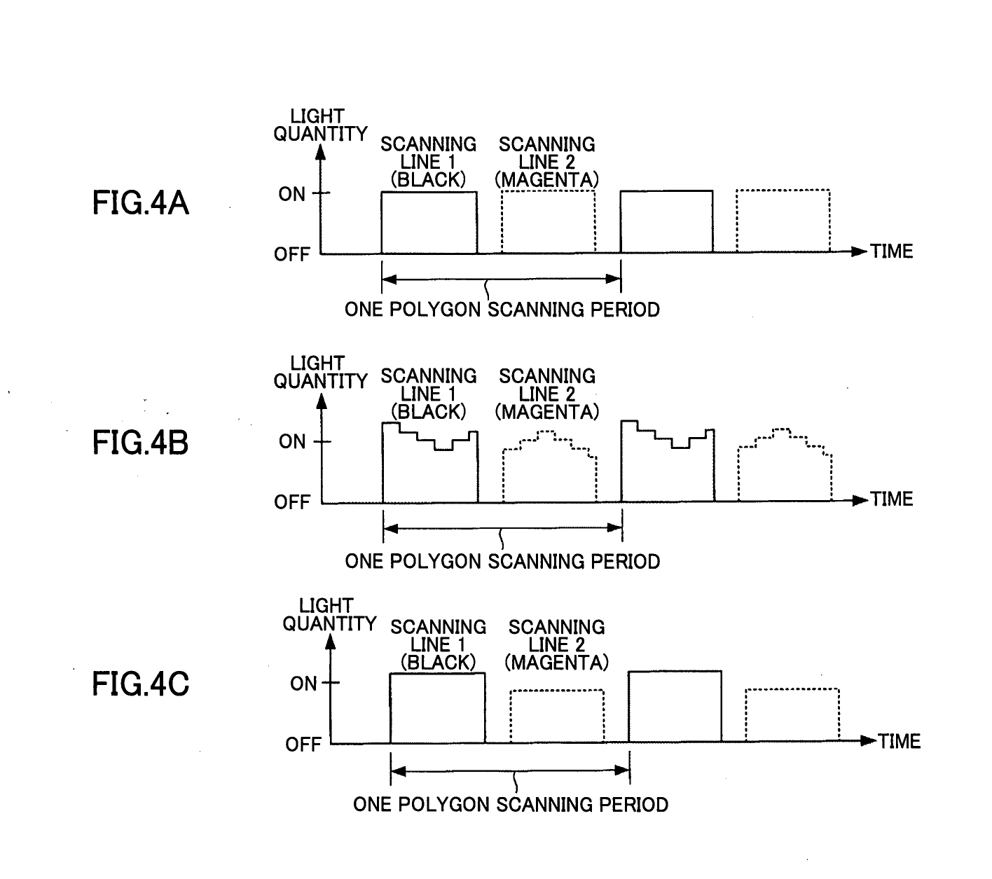

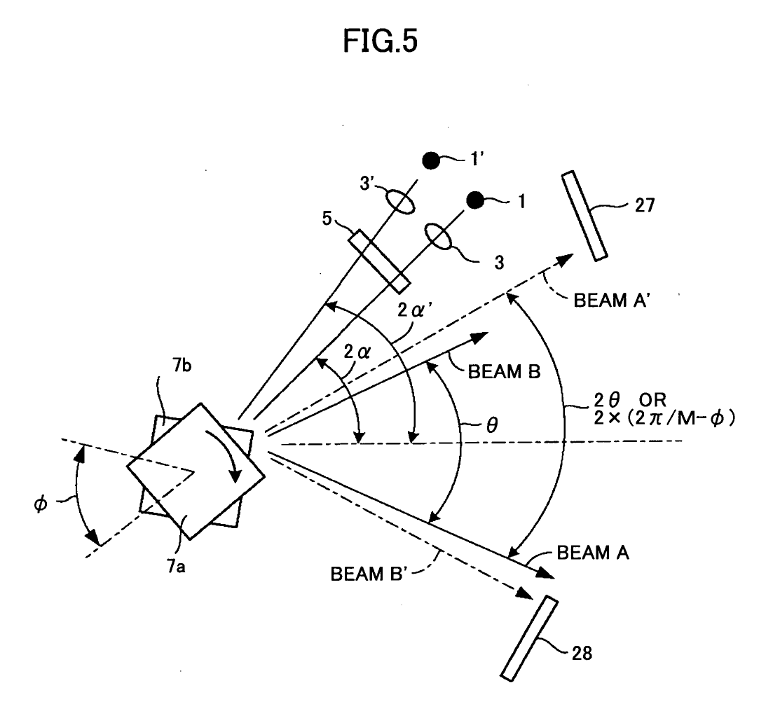

FIG. 4A provides a time chart for black and magenta lights exposed from a common light source to the entire effective scanning area. The solid lines indicate light exposure corresponding to black, and the dotted lines indicate light exposure corresponding to magenta. The write start timings of black and magenta are determined by detecting scanning beams with synchronous accepting units 27, 28, which are disposed outside effective scan widths, as shown in FIG. 5. Photodiodes are typically used as the synchronous accepting units 27, 28.

Both light beams need not be synchronized, and therefore, the synchronous accepting unit 27 provided at the scan starting side detects only a light beam A′ from the light source 1, and the synchronous accepting unit 28 provided at the scan ending side detects only a light beam B′ from the light source 1′. An image is written in an area between a light beam B and a light beam A illustrated by solid lines (angle θ).

When a surface is scanned by a light beam, the light quantity varies according to the position on the surface in the main scanning direction (image height). The light quantity varies due to factors such as absorption of light by lenses before the light beam reaches the surface, incident angle properties of Fresnel reflection, incident angle properties of an optical path bending mirror treated with reflective coating, and diffusion caused by a coarse mirror surface. This variation in light quantity is referred to as a “shading property”.

The shading property usually occurs by approximately 10%, considering the range of the maximum value and the minimum value in the effective scanning area. In an optical scanner in a tandem type image forming apparatus, the reflection angles and numbers of mirrors are different among the surfaces subject to scanning (image carriers), and therefore, the extent of the shading property is different among the surfaces.

Further, irregularities caused by allowable errors in optical elements (irregularity of the optical element itself, installation errors, etc.) also make the shading property different among the surfaces.

If the surfaces of the photoconductors have different shading properties, the image forming apparatus produces an image with color irregularities.

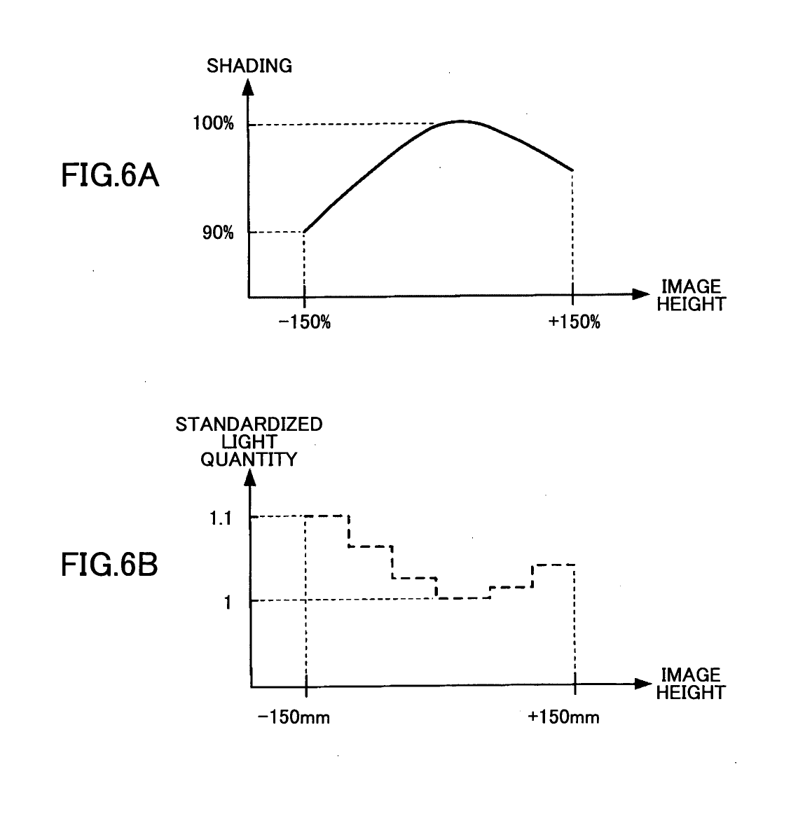

The shading property can be corrected, for example, by dividing an image forming area into a plurality of sections (preferably 10 to 20 sections), and adjusting the light quantity for each section. FIGS. 6A, 6B describe a method of correcting light quantities according to shading properties.

When the shading properties are as indicated in FIG. 6A, the preferable correction amounts of the shading properties are shown in FIG. 6B, such that the correction amounts are inverse to the shading properties. In other words, the light quantity is increased where the extent of shading is small.

The shading properties are corrected in a step-wise manner in the method shown in FIG. 6B. However, the method is not limited to this example. The correction can also be made so as to form a line graph.

In the conventional technology, there is a single light source provided for a single surface to be scanned, and therefore, shading correction can be performed by storing one set of shading correction data (light quantity correction data) of the surface, and consistently operating the light source based on the stored correction data. However, in the present embodiment, a light beam from a single light source is divided into a plurality of light beams, and the divided light beams each scan different surfaces. Therefore, shading properties of different surfaces cannot be corrected by using a single set of correction data.

Accordingly, a single light source is provided in advance with plural sets of light quantity correction data corresponding to plural surfaces to be scanned, so that the light source can use different sets of light quantity correction data according to the surface. As a result, images can be output at high speed even with a reduced number of light sources, and color irregularities can be appropriately corrected.

FIG. 4B provides a time chart for describing how light quantity correction data sets are switched for different surfaces to be scanned (black and magenta).

When a preferable shading property is achieved (uniform light quantity along the total image height) by adjusting coating conditions of the mirror, shading correction may not be needed. However, it is very difficult to make plural surfaces receive the same absolute light quantity, because the reflection angles and numbers of mirrors are different among the surfaces. Therefore, as shown in FIG. 4C, it is necessary to at least switch preset light quantities for different surfaces, so that the different surfaces receive the same light quantity from light beams.

As described above, the concept of “changing light quantity correction data for different surfaces” includes the operation of “switching preset light quantities for different surfaces”.

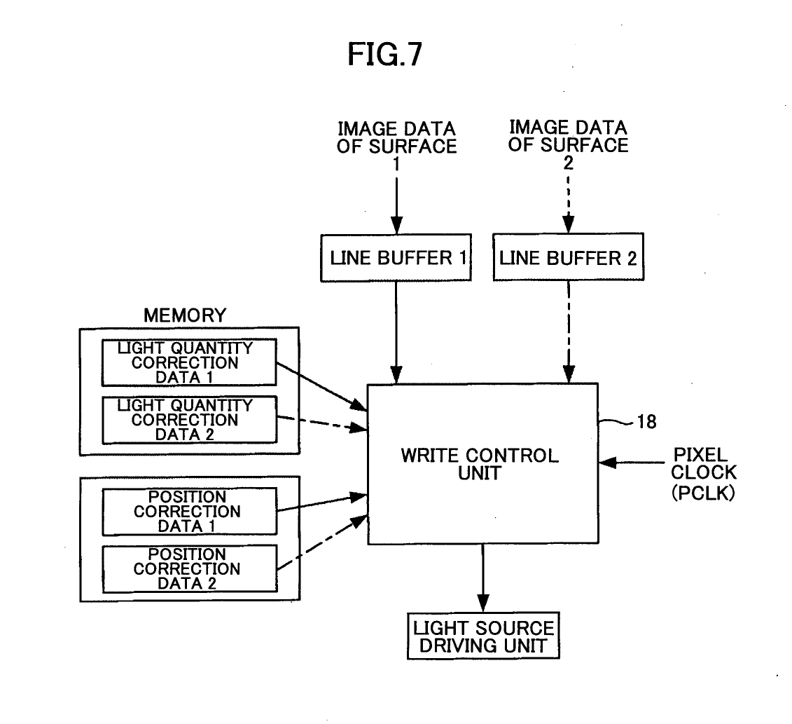

The light quantity correction (changing light quantity correction data for different surfaces) is performed by a write control unit 18, functioning as a light quantity correcting unit, as shown in FIG. 7.

FIG. 7 is a block diagram for describing how light quantity correction data or position correction data (in this example, light quantity correction data) are switched for different surfaces, in an optical scanner in which a light beam emitted from a single light source is divided into a plurality of light beams and the divided light beams scan different surfaces on a time-division manner.

A pixel clock (PCLK) generated in a high-frequency clock generating unit (not shown) is input to the write control unit 18.

The write control unit 18 generates modulation data by allocating image data in each of the pixels on the basis of the pixel clock. In generating the modulation data, the write control unit 18 controls the period, the phase, and the signal level of the modulation data based on position correction data and light quantity correction data held in a memory, and drives the light source accordingly, so that the optical scanning is performed with corrected light quantities.

When a surface 1 is being optically scanned, light quantity correction data 1 is used to control the modulation data. The electric circuit is configured such that when the subject of optical scanning switches from the surface 1 to a surface 2, the data set used for the control is switched from light quantity correction data 1 to light quantity correction data 2.

This example also includes a beam spot positional shift correcting function that uses the position correction data; however, the write control unit 18 can be configured to use only the light quantity correction data.

Practical data of the optical system according to the present embodiment are described below.
Light source wavelength: 655 nm
Coupling lens focal length: 15 mm
Coupling effect: collimate effect
Polygon mirror
Number of deflecting reflection surfaces: 4
Radius of inscribed circle: 7 mm
Upper level and lower level shifted from each other at an angle φ of 45 (deg)=45×Π/180 (rad)
Average incident angle to reflection mirror
   α=28.225(deg)=Π×28.225/180 (rad)
   Further, a cylindrical lens having a focal length of 110 mm is disposed between the light flux dividing unit and the deflecting unit, for converting light beams into long line images in the main scanning direction near the deflecting mirror.

Lens data of lenses provided beyond the deflecting unit are given below.

A first surface of a scanning lens 1 and both surfaces of a scanning lens 2 are expressed by formulas (1), (2).
Main scanning non-circular arc formula
The main scanning surface forms a non-circular arc.
A depth X in the optical axis direction is expressed by the following polynomial, where a paraxial curvature radius inside the main scanning surface of the optical axis is Rm, the distance in the main scanning direction from the optical axis is Y, the conical constant is K, and the higher coefficients are A1, A2, A3, A4, A5, A6 . . . :
   X=(Yˆ2/Rm)/[1+√{1−(1+K)(Y/Rm)ˆ2}+A1·Y+A2·Yˆ2+A3·Yˆ3+A419 Yˆ4+A5·Yˆ5+A6·Yˆ6+ (1)
When values other than zero are substituted into the odd order numbers A1, A3, A5 . . . , an asymmetric shape in the main scanning direction is obtained.
The first, second and third embodiments use only even order numbers, and therefore a symmetric shape in the main scanning direction is obtained.
Sub scanning curvature formula
Formula (2) expressing how the sub scanning curvature changes according to the main scanning direction is given below.
   Cs(Y)=1/Rs(0)+B1·Y+B2·Yˆ2+B3·Yˆ3+B4·Yˆ4+B5·Yˆ5+ (2)
When values other than zero are substituted into the odd number power coefficients of Y, As1, As3, As5 . . . , the curvature radius of sub scanning becomes asymmetric in the main scanning direction.

A second surface of the scanning lens 1 is a rotationally symmetric aspheric surface, which is expressed by the following formula.
Rotationally symmetric aspheric surface A depth X in the optical axis direction is expressed by the following polynomial expression, where a paraxial curvature radius of the optical axis is R, the distance in the main scanning direction from the optical axis is Y, the conical constant is K, the higher coefficients are A1, A2, A3, A4, A5, A6 . . . :
   X=(Yˆ2/R)/[1+√{1−(1+K)(Y/Rm)ˆ2}+A1·Y+A2·Yˆ2+A3·Yˆ3+A4·Yˆ4+A5·Yˆ5+A6·Yˆ6+ (3)
   Shape of first surface of scanning lens 1
Rm=−279.9, Rs=−61.
K −2.900000E+01
A4 1.755765E−07
A6 −5.491789E−11
A8 1.087700E−14
A10 −3.183245E−19
A12 −2.635276E−24
B1 −2.066347E−06
B2 5.727737E−06
B3 3.152201E−08
B4 2.280241E−09
B5 −3.729852E−11
B6 −3.283274E−12
B7 1.765590E−14
B8 1.372995E−15
B9 −2.889722E−18
B10 −1.984531E−19
   Shape of second surface of scanning lens 1 R=−83.6
K −0.549157
A4 2.748446E−07
A6 −4.502346E−12
A8 −7.366455E−15
A10 1.803003E−18
A12 2.727900E—23
   Shape of first surface of scanning lens 2
   Rm=6950 Rs=110.9
K 0.000000+00
A4 1.549648E−08
A6 1.292741E−14
A8 −8.811446E−18
A10 −9.182312E−22
B1 −9.593510E−07
B2 −2.135322E−07
B3 −8.079549E−12
B4 2.390609E−12
B5 2.881396E−14
B6 3.693775E−15
B7 −3.258754E−18
B8 1.814487E−20
B9 8.722085E−23
B10 −1.340807E−23
   Shape of second surface of scanning lens 2
Rm=766 Rs=−68.22
K 0.000000+00
A4 -1.150396E−07
A6 1.096926E−11
A8 −6.542135E−16
A10 1.984381E—20
A12 −2.411512E−25
B2 3.644079E−07
B4 −4.847051E−13
B6 −1.666159E−16
B8 4.534859E−19
B10 −2.819319E−23
   The refractive index in the operating wavelength of all scanning lenses is 1.52724.

The optical layout is described below.
Distance d1 from deflection surface to first surface of scanning lens 1: 64 mm
Central thickness d2 of scanning lens 1: 22.6 mm
Distance d3 from second surface of scanning lens 1 to first surface of scanning lens 2: 75.9 mm
Central thickness d4 of scanning lens 2: 4.9 mm
Distance d5 from second surface of scanning lens 2 to surface to be scanned: 158.7 mm

The noise insulating glass 6 and a dust-proof glass of a refractive index of 1.514 and a thickness of 1.9 mm are disposed. The noise insulating glass 6 is tilted by 10 degrees with respect to a direction parallel to the main scanning direction in the deflection rotational surface.

Although not shown in the figure, the dust-proof glass is disposed between the scanning lens 2 and the surface to be scanned.

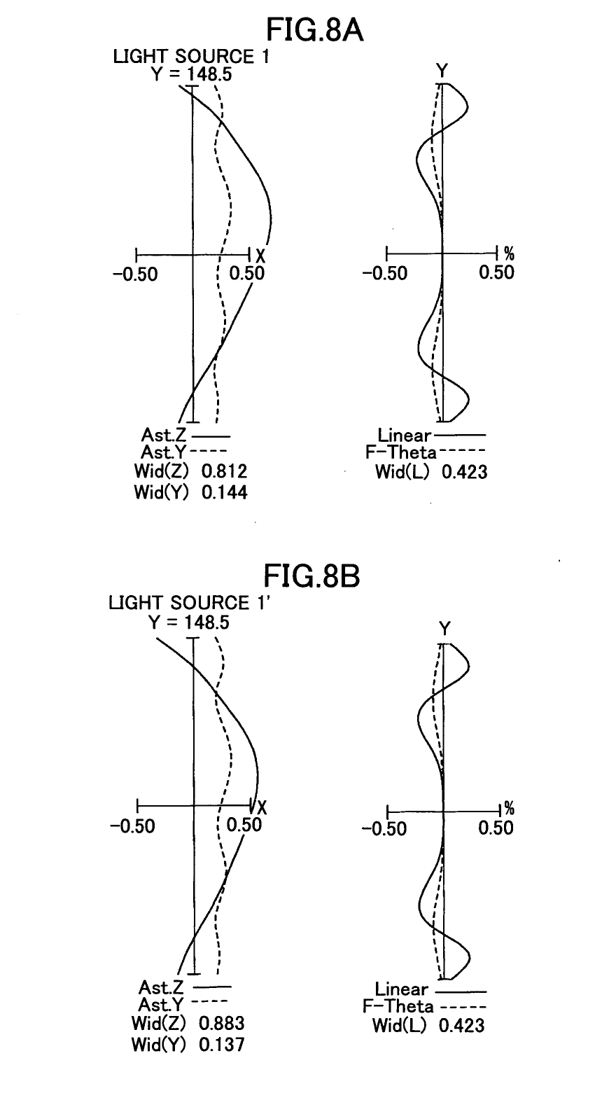

FIGS. 8A, 8B provide aberration diagrams of the light sources 1, 1′, respectively. The left diagrams indicate field curvatures (dotted line indicates main scanning field curvature, solid line indicates sub scanning field curvature), and right diagrams indicate uniform properties (dotted line indicates fθ property, solid line indicates linearity). In either case, the correction is performed appropriately.

Further, the aperture 25 having a main scanning width 7 mm and a sub scanning width 2.14 mm is disposed between the coupling lens and the cylindrical lens.

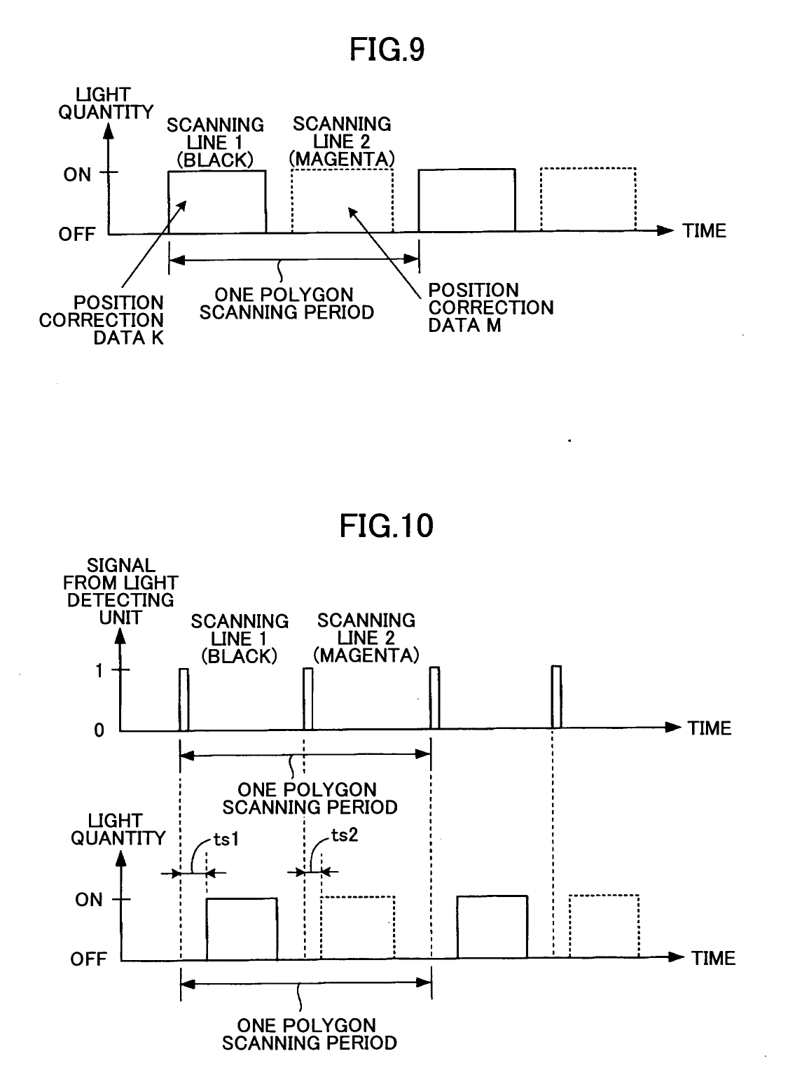

A second embodiment according to the present invention is described with reference to FIG. 7 and FIG. 9. Elements corresponding to those in the first embodiment are denoted by the same reference numbers, configurations and functions are not described unless necessary, and only relevant parts are described (the same applies to other embodiments).

In a multi-color image forming apparatus, beam spot positional shift components that cause color shifts in the main scanning direction can be classified broadly into the following three categories:
(1) Shift in write start position of image
(2) Shift of total width of image
(3) Beam spot positions are not evenly spaced apart, i.e., intervals between beam spot positions are uneven

The following are examples of methods for correcting the above three categories, respectively:
(1) Correct the write start timing of an image
(2) Correct the clock frequency driving the light source.
(3) Partially change the clock frequency driving the light source, so that the clock is not constant.

Optical elements (scanning lens, optical path bending mirror, etc.) through which a light beam passes before reaching the surfaces are different among the surfaces. Therefore, if different surfaces are scanned by using the same position correction data (the write start timing of an image, the clock frequency, and the partial clock frequency as described above), the surfaces will have different beam spot positions, which lead to a color shift.

In order to correct the color shift, the three data items (the write start timing of an image, the clock frequency, and the partial clock frequency) need to be corrected for each surface.

In the conventional technology, a single light source is provided for a single surface to be scanned. Therefore, each light source can consistently use the same position correction data set therein (the write start timing of an image, the clock frequency, and the partial clock frequency), to obtain a preferable color image in which color shifts are corrected.

However, in the present embodiment, a light beam from a single light source is divided into a plurality of light beams, and each of the divided light beams scans different surfaces. Therefore, color shifts cannot be corrected by using a single set of position correction data.

Accordingly, the position correction data set is switched for different surfaces. As a result, images can be output at high speed even with a reduced number of light sources, and color shifts can be appropriately corrected.

FIG. 9 provides a time chart for describing how position correction data are switched for different surfaces to be scanned (black and magenta). As shown in FIG. 9, when a surface for black is being scanned, position correction data set K is used, and when a surface for magenta is being scanned, the data set used is switched to position correction data set M.

In the conventional technology, the position correction data cannot be switched between K and M, and therefore, the same position correction data are used for plural surfaces.

As described with reference to FIG. 7, a pixel clock (PCLK) generated by the high-frequency clock generating unit is input to the write control unit 18, functioning as a beam spot position correction unit, as shown in FIG. 7. The write control unit 18 generates modulation data by allocating image data in each of the pixels on the basis of the pixel clock.

In generating the modulation data, the write control unit 18 controls the period, the phase, and the signal level of the modulation data based on light quantity correction data or position correction data (in this example, position correction data) held in a memory, and drives the light source accordingly, so that beam spot positions are corrected in the optical scanning.

When a surface 1 is being optically scanned, position correction data set 1 is used to control the modulation data. The electric circuit can be configured such that when the subject of optical scanning is switched from the surface 1 to a surface 2, the data set used for the control is switched from position correction data set 1 to position correction data set 2.

Detailed descriptions of the write start timing of an image, the clock frequency, and the partial clock frequency are given below.

In the optical scanner of the example described above, a light beam is emitted from a single light source and scans a plurality of different surfaces. Specifically, light flux is divided into a plurality of light beams by the light flux dividing unit, and the divided light beams are guided to different levels of the deflecting unit. Different levels of the polygon mirror are offset from each other by an angle φ in the rotational direction. The divided light beams scan the different surfaces on a time-division manner. However, the present invention is not limited to this example.

A light beam from a single light source can be made to scan a plurality of different surfaces.

There are other methods of making a light beam from a single light source scan a plurality of different surfaces. For example, a deflecting unit including polygon mirrors having surfaces of different angles in the sub scanning direction can be used, so that light beams of different angles are output from the different surfaces of the deflecting unit, to scan different surfaces on a time-division manner. Further, Japanese Laid-Open Patent Application Nos. 2000-238321 and 2005-010268 disclose methods of switching the light path using a light path switching unit to scan a plurality of different surfaces.

A third embodiment according to the present invention is described with reference to FIG. 7 and FIG. 10.

The write start timing of an image is described in the present embodiment. When scanning a surface with an optical scanner, the write start timing of an image is determined on the basis of a light detection timing detected by a light detecting unit such as a photodiode provided at the starting side of optical scanning and outside the image forming area. Specifically, the write start timing is the timing of starting to write an image at a starting point of the image forming area after a light is detected by the light detecting unit.

Even if the write start timing is the same for different surfaces, the light beams pass through different optical systems before reaching the surfaces to be scanned. As a result, the surfaces have different write start positions, which may lead to color shifts in the resultant image. To compensate for the differences, it is necessary to adjust the write start timing of an image for each surface to be scanned.

The write start timing of an image can be corrected by adjusting the timing of starting to write an image after a light is detected by the light detecting unit. By switching the write start timing of an image for each of the different surfaces to be scanned, images can be output at high speed even with a reduced number of light sources, and color shifts can be appropriately corrected.

FIG. 10 provides a time chart for describing how the write start timing of an image is switched for different surfaces to be scanned (black and magenta). In FIG. 10, ts1 denotes the write start timing corresponding to black, and ts2 denotes the write start timing corresponding to magenta. Every time the light detecting unit detects a signal, the write start timing is switched between ts1 and ts2.

The write start timing is switched by the write control unit 18 shown in FIG. 7, functioning as the beam spot position correction unit. In the present embodiment, position correction data held in the memory are used as correction data. The position correction data can be used to control the write start timing of the image.

When a single light source is provided for a single surface to be scanned as in the conventional technology, only one write start timing (ts0) is used for each surface, without switching between ts1 and ts2.

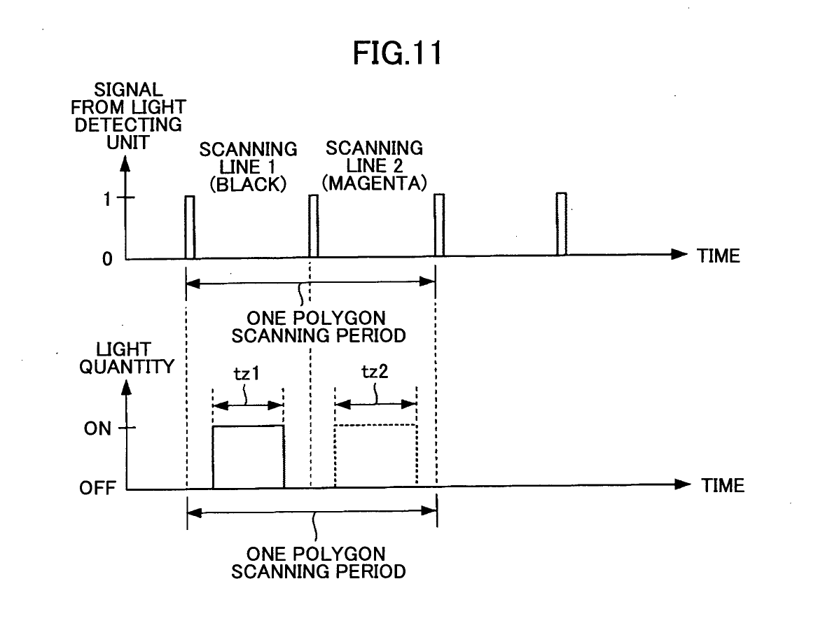

A fourth embodiment according to the present invention is described with reference to FIG. 7 and FIG. 11.

The clock frequency is described in the present embodiment. As described above, even if the same clock frequency is used for scanning a plurality of different surfaces, optical elements (scanning lens, optical path bending mirror, etc.) through which a light beam passes before reaching the surfaces are different among the surfaces. Therefore, images created on the different surfaces will have different total widths.

Moreover, the temperatures of scanning lenses (made of plastic) may differ in the environment where the image forming apparatus is used, and therefore, the scanning lenses may have different expansion coefficients. Accordingly, images created on the different surfaces will have different total widths.

The total width of an image can be corrected by changing the clock frequency of the light source. By switching the clock frequency of the light source for different surfaces to be scanned, images can be output at high speed even with a reduced number of light sources, and color shifts can be appropriately corrected.

FIG. 11 provides a time chart for describing how the clock frequency of the light source is switched for different surfaces to be scanned (black and magenta). In FIG. 11, tz1 denotes the total width corresponding to black, and tz2 denotes the total width corresponding to magenta. Every time the light detecting unit detects a signal, the total width is switched between tz1 and tz2.

The clock frequency is switched by the write control unit 18 shown in FIG. 7, functioning as the beam spot position correction unit. In the present embodiment, position correction data held in the memory are used as correction data. The position correction data can be used to control the clock frequency.

When a single light source is provided for a single surface to be scanned, as in the conventional technology, only one total width (tz0) is used for each surface without switching between tz1 and tz2.

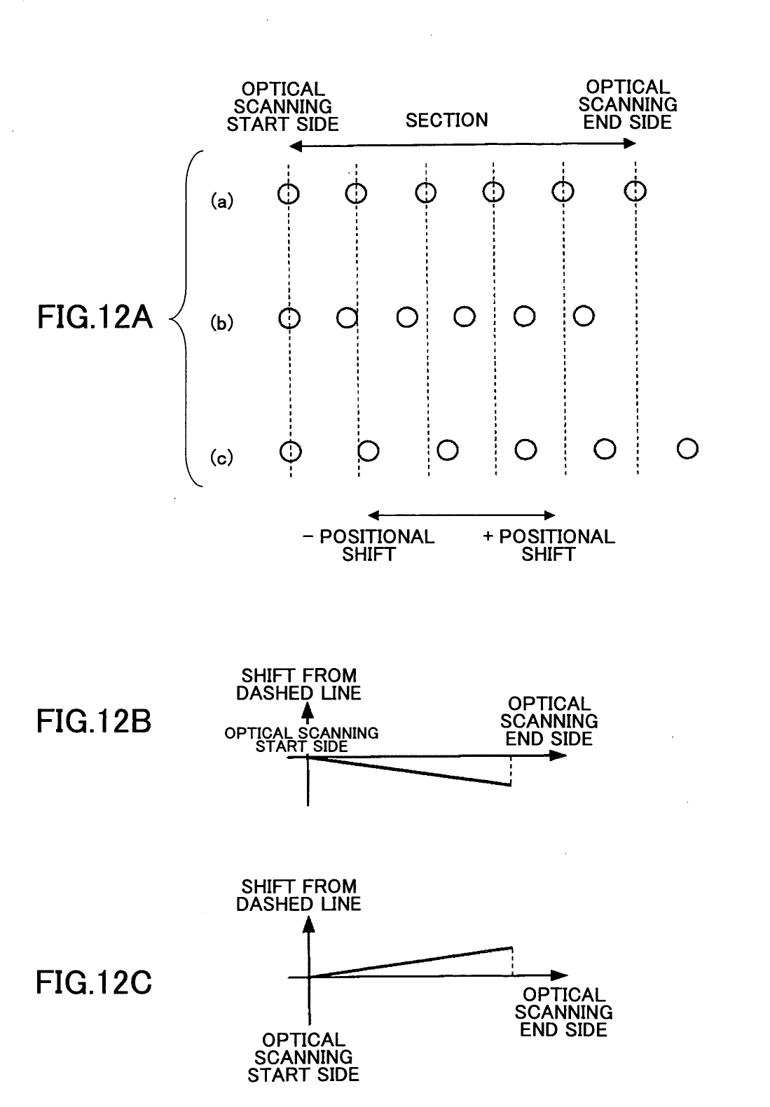

A fifth embodiment according to the present invention is described with reference to FIG. 7 and FIGS. 12A, 12B, 12C.

The partial clock frequency is described in the present embodiment. Even if the write start position of an image and the total width of an image were the same for a plurality of surfaces to be scanned, color shifts occur in the middle area of an image (between edges of the image).

Specifically, even if the light source is driven at a certain clock frequency, beam spot positions are not evenly spaced apart on the surface to be scanned, i.e., intervals between beam spot positions are uneven. The unevenness of intervals is different among the surfaces to be scanned, and therefore, color shifts occur in the middle area of an image (between edges of an image).

The unevenness of intervals is different among the surfaces to be scanned because optical elements (scanning lens, optical path bending mirror, etc.) through which a light beam passes before reaching the surfaces are different among the surfaces. In fabricating optical elements (scanning lens), irregularities in the surface shapes inevitably occur.

Uneven intervals between beam spot positions can be corrected by partially modulating the clock frequency of the light source according to the conditions of the intervals between beam spot positions, instead of having a fixed clock frequency. Accordingly, intervals between beam spot positions can be made substantially even.

The conditions of the intervals between beam spot positions can be determined by detecting toner patches, or by arraying beam spot detecting units (such as photodiodes) and measuring the time between units, or by measuring output images. Specific methods for correcting uneven intervals between beam spot positions will be described later.

By switching data used for correcting uneven intervals between beam spot positions (unevenness correction data) for different surfaces to be scanned, images can be output at high speed even with a reduced number of light sources, and color shifts can be appropriately corrected.

The optimal method of correcting uneven intervals between main scanning beam spot positions according to the present invention (correcting partial magnification errors) is to divide an effective scanning area into a plurality of sections, and make corrections by each section. The reason is described below.

When correcting color shifts by correcting unevenness of intervals between beam spot positions, it is very troublesome to make the corrections if “as color shift is corrected in one part, color shift occurs in another part”. With the method of dividing an effective scanning area into a plurality of sections and making corrections by each section, each section can be corrected independently. Thus, corrections can be selectively made; for example, it is possible to “perform color shift correction by an arbitrary amount in only one area, and do not perform color shift correction in other areas.” Accordingly, correction is independently performed only in the area where color shift has occurred. As a result, color shift corrections can be performed very easily, and color shift correction algorithms and color shift circuits can be simplified.

Other advantages of making corrections by divided sections are that it is possible to reduce the amount of correction data to be held in a correction information storing unit, so that the circuit can be made compact and costs can be reduced. Further, the circuit can be simplified, so that power consumption can be reduced. Details are described below.

When an effective scanning area is divided into sections, a fixed correction rule (function) is determined in accordance with unevenness of intervals between beam spot positions in each section. When an effective scanning area is not divided into sections, it is necessary to determine a fixed correction rule (function) in accordance with unevenness of intervals between beam spot positions in the entire effective scanning area (image area).

The unevenness of intervals between beam spot positions appears to be very complicated in the entire effective scanning area. Therefore, to apply a polynomial including many orders, the polynomial needs to have at least eight orders, and the coefficients of the items need to have many digits, which require enormous memory capacity.

However, by dividing the effective scanning area into sections, the unevenness of intervals between beam spot positions appears to be simple. Therefore, a polynomial of only one order is sufficient for making corrections appropriately (e.g., extend or shorten the intervals by a fixed proportion). By dividing the effective scanning area into sections and making corrections by each section, color shifts can be corrected appropriately with a significantly reduced memory capacity for loading correction data, so that the circuit can be made compact and costs and power consumption can be reduced.

The following is a description of the method of dividing an effective scanning area into a plurality of sections and correcting beam spot positions by each section to correct uneven intervals between beam spot positions.

First, a single section is considered. FIG. 12A is a diagram indicating beam spot positions in one section before the correction is made. It is assumed that optical scanning is performed from the left to the right side of a sheet of paper. The dashed lines in the figure are evenly spaced apart, and beam spot positions are ideally located on these dashed lines. However, the beam spot positions are usually not located on these dashed lines due to the above-described factors.

In a state indicated by (a) of FIG. 12A, the beam spot positions are located on the dashed lines as a matter of description. In reality, before the correction is made, the beam spot positions are shifted from the dashed lines, and it is necessary to correct this shift.

In a state indicated by (b) of FIG. 12A, intervals between the beam spot positions are equally shortened. This is expressed by a graph in FIG. 12B. The vertical axis represents positional shifts from the dashed lines, the horizontal axis represents the beam spot positions in the optical scanning direction, and the graph is sloping downward. In a state indicated by (c) of FIG. 12A, intervals between the beam spot positions are equally extended. This is expressed by a graph in FIG. 12C. The vertical axis represents positional shifts from the dashed lines, the horizontal axis represents the beam spot positions in the optical scanning direction, and the graph is sloping upward.

In this example, it is assumed that a shift to the right side of a dashed line on a sheet is positive, and a shift to the left side of a dashed line on a sheet is negative. The slope of the graph is determined by amounts of shortening (extending) intervals between beam spot positions. As the intervals between beam spot positions are shortened (extended) to a larger extent, the slope of the graph becomes more precipitous.

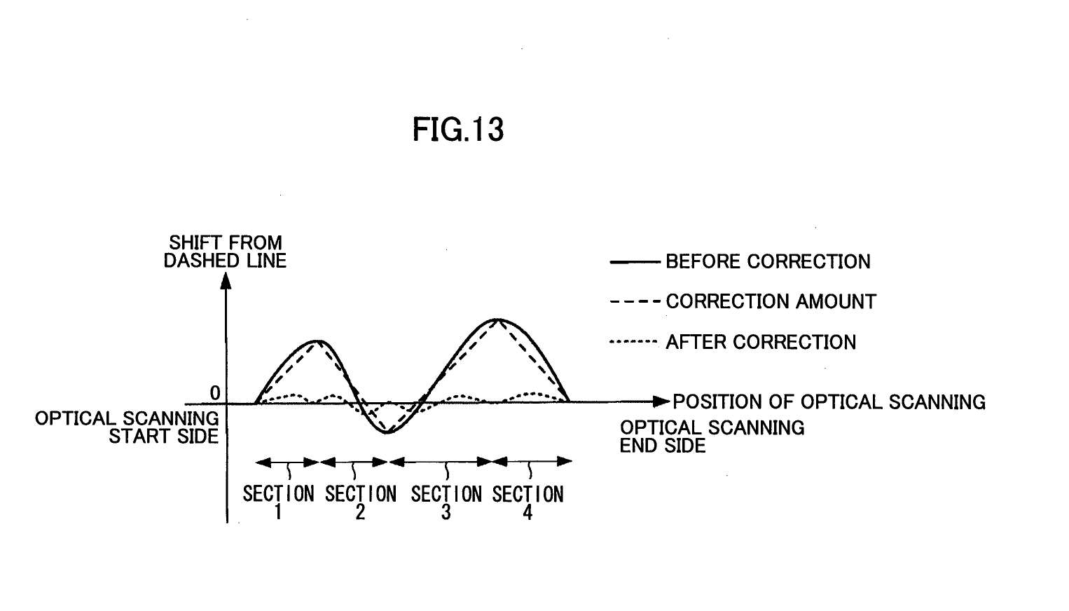

Next, a combination of a plurality of sections is considered. The solid line shown in FIG. 13 represents shifts of beam spot positions before corrections, which indicates shifts from the dashed lines (evenly spaced apart) shown in FIG. 12A.

In sections 1, 3, intervals between the beam spot positions are wide, as in the state indicated by (c) in FIG. 12A. In sections 2, 4, intervals between the beam spot positions are narrow, as in the state indicated by (b) in FIG. 12A. Therefore, in sections 1, 3, intervals between the beam spot positions are to be shortened, toward the interval state indicated by (b) in FIG. 12A. Meanwhile, in sections 2, 4, intervals between the beam spot positions are to be extended, toward the interval state indicated by (c) in FIG. 12A. Correction of intervals between beam spot positions is performed by the write control unit 18, functioning as the beam spot position correction unit, as shown in FIG. 7. In the present embodiment, position correction data held in a memory are used as correction data. The position correction data can be used to control the lengths of intervals between beam spot positions.

As described above, a combination of the interval states indicated by (b) and (c) in FIG. 12A is used to appropriately shorten (extend) intervals between beam spot positions, thereby making corrections as indicated by a thick dashed line shown in FIG. 13. Accordingly, the interval state before correction represented by the solid line is corrected to the interval state represented by a thin dashed line shown in FIG. 13. Thus, by using the method according to the present embodiment, unevenness of intervals between beam spot positions can be corrected with high precision.

A sixth embodiment according to the present invention is described with reference to FIGS. 7, 14, 15A, 15B, 15C, 16, and 17A, 17B, 17C.

In each section, phases of pixel clock signals are shifted to adjust the timing of emitting the light beams. Accordingly, unevenness of intervals between beam spot positions is corrected.

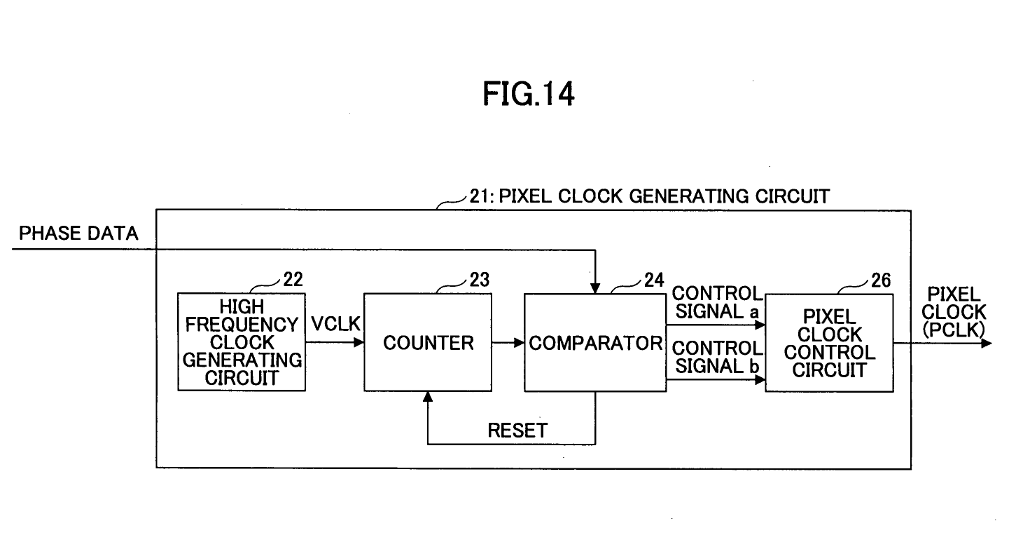

The following is a description of the principle of changing the period of a pixel clock on the basis of phase data indicating a transition timing of the pixel clock, with reference to FIGS. 14, 15A, 15B, 15C, 16.

A pixel clock generating circuit 21 shown in FIG. 14 includes a high frequency clock generating circuit 22, a counter 23, a comparator 24, and a pixel clock control circuit 26. The high frequency clock generating circuit 22 generates a high frequency clock VCLK, which is used as a basis for a pixel clock PCLK.

The counter 23 starts operating as the VCLK rises, and counts the VCLK. The comparator 24 compares the values output from the counter 23 with preset values and phase data received from outside. The phase data indicate the amount of phase shift as transition timing of a pixel clock. Based on comparison results, the comparator 24 outputs control signals a, b.

The comparator 24 controls the transition timing of the pixel clock PCLK on the basis of the control signals a, b.

The phase data indicate the amount of phase shift of a pixel clock so as to make corrections, e.g., correct unevenness in optical scanning caused by properties of scanning lenses, correct positional shifts of dots caused by irregular rotations of the polygon mirror, or correct positional shifts of dots caused by color aberrations of laser beams.

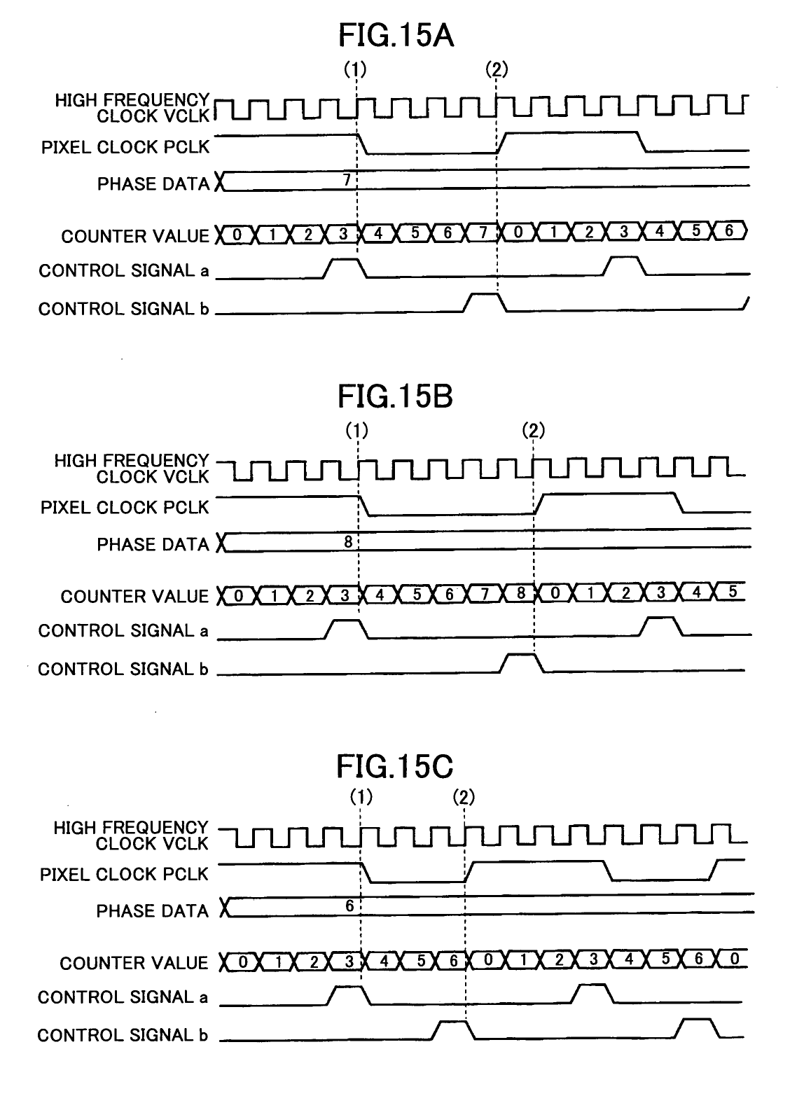

Operations of the pixel clock generating circuit 21 are described with reference to timing charts shown in FIGS. 15A, 15B, 15C. In this example, the pixel clock PCLK corresponds to eight frequency divisions of the high frequency clock VCLK, and the standard duty ratio is 50%.

FIG. 15A is a diagram for describing generation of a standard pixel clock PCLK having a duty ratio of 50%, corresponding to eight frequency divisions of the high frequency clock VCLK. FIG. 15B is a diagram for describing generation of PCLK whose phase is advanced by ⅛ clock with respect to the eight frequency division clock of VCLK. FIG. 15C is a diagram for describing generation of PCLK whose phase is delayed by ⅛ clock with respect to the eight frequency division clock of VCLK.

First, FIG. 15A is described. In this example, a value “7” is provided as phase data. In the comparator 24, a value “3” is set in advance. The counter 23 starts operating as the VCLK rises, and counts the VCLK.

When the value output from the counter 23 reaches “3”, the comparator 24 outputs the control signal a. As the control signal a becomes “H” at a clock timing denoted by (1), the pixel clock control circuit 26 causes the pixel clock PCLK to make a transition from “H” to “L”. Next, the comparator 24 compares the provided phase data with the value output from the counter 23, and when they match, the comparator 24 outputs the control signal b. In the example shown in FIG. 15A, when the value output from the counter 23 reaches “7”, the comparator 24 outputs the control signal b. As the control signal b indicates “H”, the pixel clock control circuit 26 causes the pixel clock PCLK to make a transition from “L” to “H” at a clock timing denoted by (2). At this point, the comparator 24 resets the counter 23 to “0”, and causes the counter to start counting over again.

Accordingly, as shown in FIG. 15A, a pixel clock PCLK having a duty ratio of 50%, corresponding to eight frequency divisions of the high frequency clock VCLK, is generated. By changing a preset value in the comparator 24, the duty ratio can be changed.

Next, FIG. 15B is described. In this example, a value “8” is provided as phase data. The counter 23 counts the high frequency clock VCLK. When the value output from the counter 23 reaches “3”, the comparator 24 outputs the control signal a. As the control signal a becomes “H” at a clock timing denoted by (1), the pixel clock control circuit 26 causes the pixel clock PCLK to make a transition from “H” to “L”. Next, when the provided phase data (in this example, 8) match the value output from the counter 23, the comparator 24 outputs the control signal b. As the control signal b indicates “H”, the pixel clock control circuit 26 causes the pixel clock PCLK to make a transition from “L” to “H” at a clock timing denoted by (2). At this point, the comparator 24 resets the counter 23 to “0”, and causes the counter to start counting over again.

Accordingly, as shown in FIG. 15B, a pixel clock PCLK, whose phase is advanced by ⅛ clock with respect to the eight frequency division clock of the high frequency clock VCLK, is generated.

Next, FIG. 15C is described. In this example, a value “6” is provided as phase data. The counter 23 counts the high frequency clock VCLK. When the value output from the counter 23 reaches “3”, the comparator 24 outputs the control signal a.

As the control signal a becomes “H” at a clock timing denoted by (1), the pixel clock control circuit 26 causes the pixel clock PCLK to make a transition from “H” to “L”. Next, when the provided phase data (in this example, 6) match the value output from the counter 23, the comparator 24 outputs the control signal b.

As the control signal b indicates “H”, the pixel clock control circuit 26 causes the pixel clock PCLK to make a transition from “L” to “H” at a clock timing denoted by (2). At this point, the comparator 24 resets the counter 23 to “0”, and causes the counter to start counting over again.

Accordingly, as shown in FIG. 15C, a pixel clock PCLK whose phase is delayed by ⅛ clock with respect to the eight frequency division clock of the high frequency clock VCLK is generated.

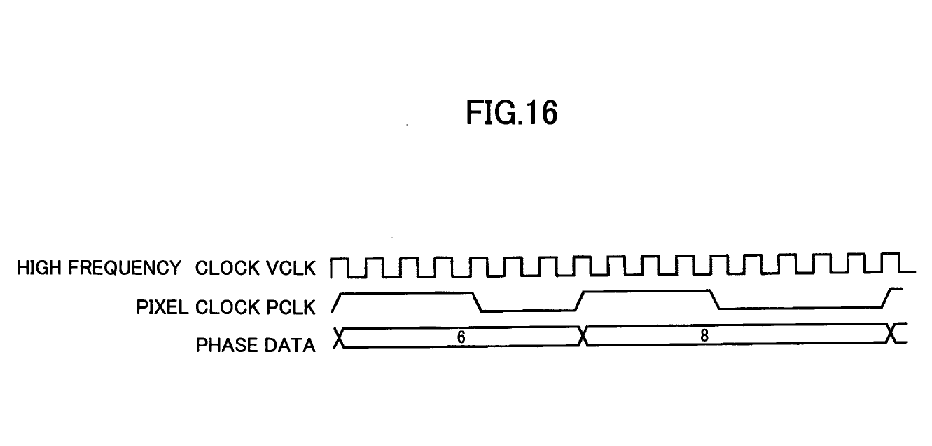

By providing the phase data in synchronization with the rise of the pixel clock PCLK, it is possible to change the phase of the pixel clock PCLK by each clock. An example of this configuration is shown in a timing chart provided by FIG. 16.

As described above, with a simple configuration, it is possible to control the phase of the pixel clock PCLK in ± directions of the high frequency clock VCLK by clock width units. In other words, it is possible to correct beam spot positions.

Correction of beam spot positions is performed by the write control unit 18, functioning as the beam spot position correction unit, as shown in FIG. 7. In the present embodiment, position correction data held in a memory are used as correction data. The position correction data can be used to control the lengths of intervals between beam spot positions, and to shift the phases of the pixel clock.

As described above, the phase of the pixel clock PCLK can be changed by one clock (i.e., by one dot),. and therefore, corrections can be made with high precision.

When the phase is changed by one clock, phase data for each clock need to be held in a memory. Thus, an enormous memory capacity is needed, which leads to increased costs. In order to reduce costs, it is possible to divide the effective scanning area into a plurality of sections, shift the phases of the pixel clock by fixed intervals in each section, and change the number of pixels subject to phase shifting in each section. Accordingly, the memory capacity can be significantly reduced.

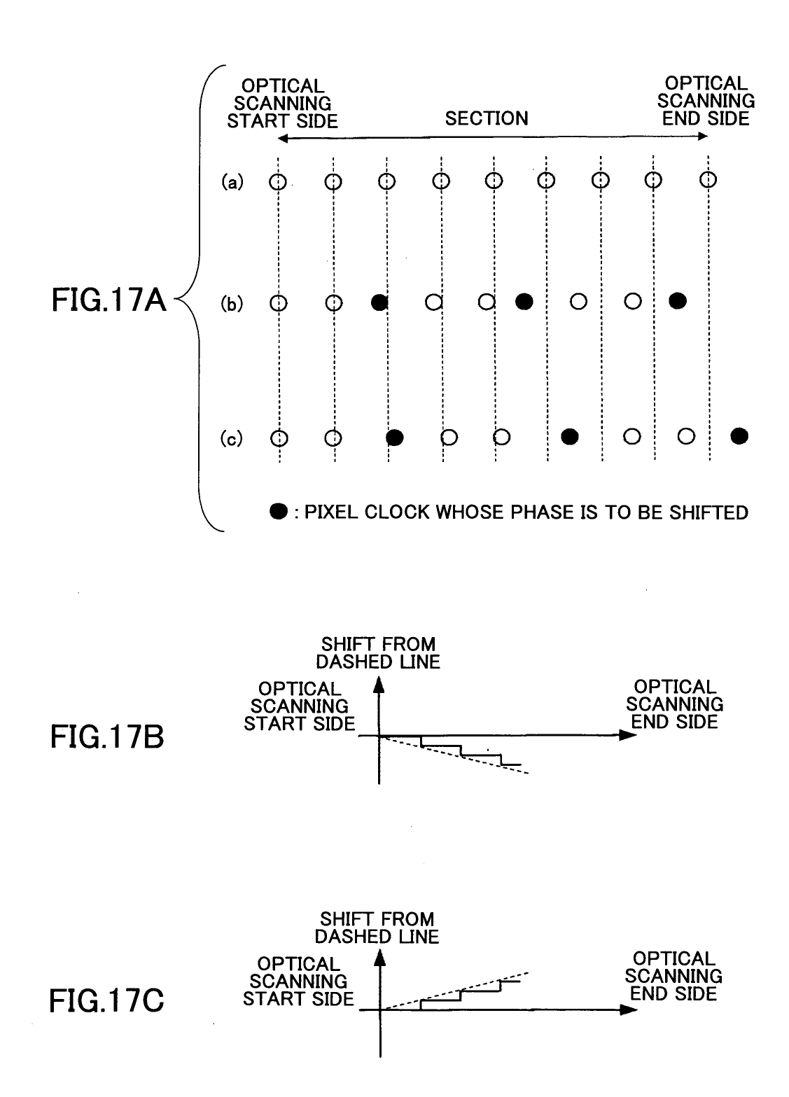

As an example of the above, FIGS. 17A, 17B, 17C are schematic diagrams and charts describing the process of shifting phases of a pixel clock for every third pixel. When shifting the phase of a pixel clock for every third pixel as shown in FIG. 17A, the beam spot positions are changed in a step-wise manner from the interval state before correction. However, the phase of the pixel clock is shifted by a small amount (for example, 1/16 pixel clock). As a result, the step-wise line appears to be approximately linear.

Moreover, the slope of the line graph can be changed by changing the interval of shifting the phase. For example, when the phase is shifted by every second pixel, the slope of the line graph becomes more precipitous (correction amount increases), and when the phase is shifted by every fourth pixel, the slope of the line graph becomes gentler (correction amount decreases).

As described above, by shifting the phases of the pixel clock by fixed intervals, and by changing the intervals of shifting the phases of the pixel clock among different sections, an approximate correction described with reference to FIG. 13 can be achieved.

The phase shift amount is preferably a fixed amount (for example, ± 1/16 pixel clock), so as to simplify the algorithm.

Further, in the above described section, the phases need not be shifted by fixed intervals between pixels; the phases can be shifted by uneven intervals according to the condition of beam spot position shifts to be corrected. Accordingly, optical scanning can be performed with high precision.

The phase data according to the present embodiment includes not only data indicating the amount of phase shift but also information about intervals between pixels at which phase shift is to be performed.

The most preferable method of correcting unevenness of intervals between beam spot positions is to shift pixel clock phases. The method of shifting phases can be performed by using a relatively simple electric circuit, and is therefore advantageous in terms of low power consumption and low cost, and also in that jitter does not occur in the clock at joints between sections.

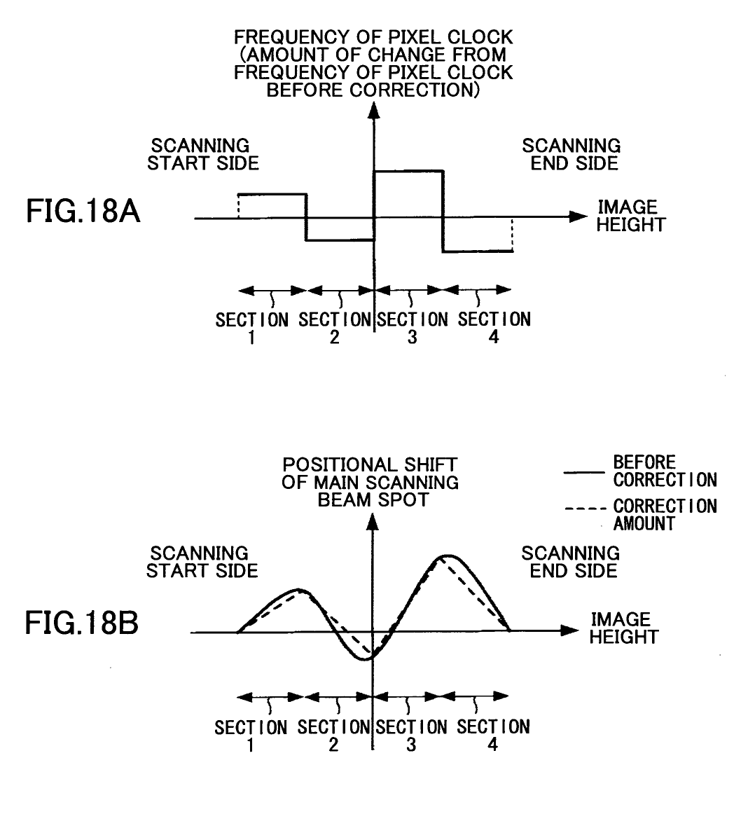

A seventh embodiment according to the present invention is described with reference to FIGS. 7 and 18A, 18B.

It is possible to correct beam spot positions by each section by changing frequencies of pixel clocks by each section. This is described with reference to FIGS. 18A, 18B.

In order to correct beam spot positions as shown by a solid line in FIG. 18B, the frequency in each section is to be changed in a step-wise manner as shown in FIG. 18A. By changing the frequency of the pixel clock in each section in a step-wise manner, the beam spot positions can be corrected in each section in a linear-functional manner. Thus, according to the amount of change of the pixel clock, the slope of the linear function can be changed.

In this example, a shift in the image height direction towards the scan-ending side is defined as a positive positional shift. The amount of change from the frequency before correction is shown in FIG. 18A. Referring to the description of FIGS. 12A, 12B, 12C, 13, intervals between beam spot positions are substantially wide in section 1 shown in FIGS. 18A, 18B. Therefore, the beam spot positions can be corrected by making the frequency higher than the frequency before correction.

In section 2, intervals between beam spot positions are substantially narrow, and therefore, the beam spot positions can be corrected by making the frequency lower than the frequency before correction. By performing corrections in a similar manner for sections 3, 4, the shifts of beam spot positions can be corrected appropriately in all sections.

Correction of beam spot positions is performed by the write control unit 18, functioning as the beam spot position correction unit, as shown in FIG. 7. In the present embodiment, position correction data held in a memory are used as correction data. The position correction data can be used to control the lengths of intervals between beam spot positions, and to change the frequency of a pixel clock.

The frequency of a pixel clock can be changed by other methods besides a step-wise manner; the frequency can be changed in a linear functional or quadratic functional manner. Accordingly, corrections can be made on the near-actual beam spot positions, so that shifts of beam spot positions can be corrected with high precision.

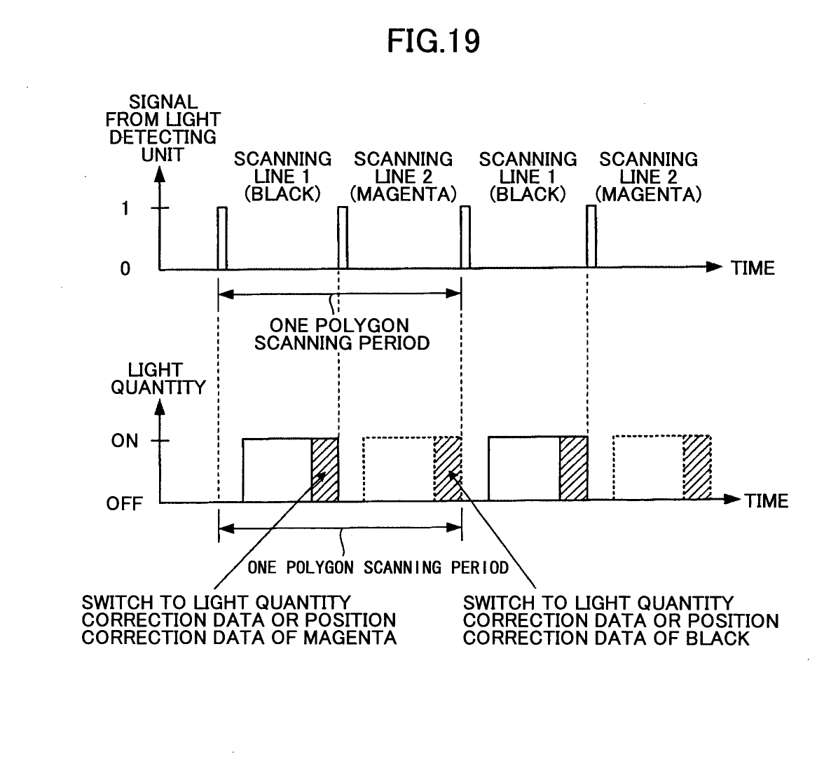

An eighth embodiment according to the present invention is described with reference to FIGS. 7 and 19.

The timing of switching light amount correction data or position correction data are described below. If light quantity correction data or position correction data is rewritten while scanning an image area, the image area is adversely affected. Therefore, the light quantity correction data or the position correction data are preferably rewritten outside the image area. A write start timing is determined after the light detecting unit (a photodiode is typically used) provided outside the image forming area and at the starting side of optical scanning detects a signal, and optical scanning starts at the write start timing. Thus, rewriting of the light quantity correction data or the position correction data is preferably completed after the image area is scanned and before the light detecting unit detects the next signal.

This is described with reference to FIG. 19. In FIG. 19, after scanning of a black image is completed and before the light detecting unit detects a signal for determining the scan start timing for a magenta image, the light quantity correction data or the position correction data are changed from the data set for black to the data set for magenta.

The light quantity correction data or the position correction data are changed by the write control unit 18, functioning as the light quantity correction unit or the beam spot position correction unit, as shown in FIG. 7.

When two light detecting units are provided outside the image area at the starting side and the ending side of optical scanning, rewriting of the light quantity correction data or the position correction data is preferably completed after the light detecting unit provided at the ending side detects a light beam and before the light detecting unit provided at the starting side detects the next signal.

In the above description, it is assumed that the light detecting unit provided outside the image area and at the starting side of optical scanning is commonly used for a plurality of colors corresponding to a plurality of beams created by dividing light flux from a single light source. This is an optimal configuration for the present invention.

However, a plurality of light detecting units can be provided individually for each color. In this case, the light quantity correction data or the position correction data are also changed.

The light quantity correction data or the position correction data are preferably held in a storing unit (e.g., a memory) (ninth embodiment).

The light quantity correction data or the position correction data are preferably held as a difference with respect to a preset standard value (tenth embodiment). Accordingly, it is possible to reduce the data amount to be held in the memory, so that the circuit can be made compact and costs can be reduced.

In the above descriptions, the half mirror prism is employed as the light flux dividing unit. The half mirror prism can minimize loss of light quantity, and is therefore the optimal light flux dividing unit for the present invention. However, the light flux dividing unit is not limited to the half mirror prism. A light beam emitted from a single light source is preferably divided by using a half mirror unit (the division ratio is not limited to 1:1) and a reflection unit (including both a reflection by a mirror and total reflection).

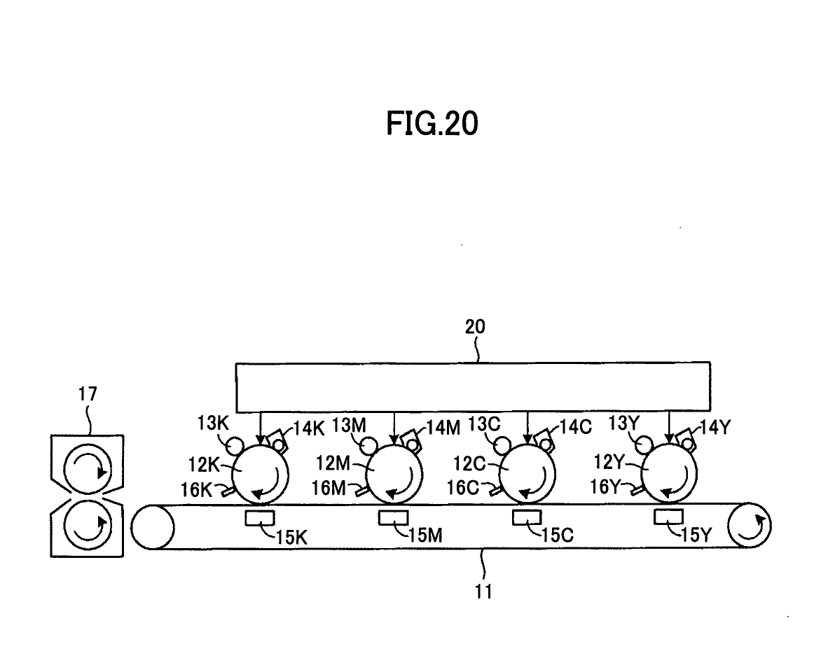

A tandem type multicolor image forming apparatus employing the above-described optical scanner is described with reference to FIG. 20 (eleventh embodiment).

The multicolor image forming apparatus includes four photoconductors 12Y, 12C, 12M, and 12K juxtaposed along a direction of movement of a transfer belt 11. The following units are provided around the photoconductor 12Y, which is used for forming yellow images, in the order indicated by an arrow therein in a rotational direction: a charging unit 13Y, a developing unit 14Y, a transfer unit 15Y, and a cleaning unit 16Y. The photoconductors corresponding to other colors have the same configuration, whose units are denoted by alphabetical letters for distinguishing the color (C: cyan, M: magenta, K: black), and descriptions thereof are omitted.

The charging unit 13 is a charging member included in a charging device for uniformly charging the surface of the photoconductor 12. An optical scanning device 20 emits a light beam onto the surface of the photoconductor 12 between the charging unit 13 and the developing unit 14, thereby forming an electrostatic latent image on the photoconductor 12.

Based on the electrostatic latent image, the developing unit 14 forms a toner image on the photoconductor surface. The transfer unit 15 transfers the toner image, so that toner images of each color are sequentially transferred from the photoconductors onto a recording medium (transfer sheet) conveyed by the transfer belt 11. The toner images superposed on each other are finally fixed onto the transfer sheet by a fixing unit 17.

A plurality of light beams emitted from the plurality of light sources 1, 1′ shown in FIGS. 1, 5 scan two different photoconductors. The light beams scan the photoconductors once, so that two scanning lines are formed on each photoconductor. At this point, it is necessary to adjust the pitches of the scanning lines in the sub scanning direction according to pixel density. A typical method of adjusting pitches is to rotate the light source unit (including the semiconductor lasers 1, 1′, the support base 2, and the coupling lenses 3, 3′) around a perpendicular axis in the main scanning direction and the sub scanning direction. Accordingly, a desirable pitch can be achieved for one photoconductor; however, a pitch error occurs for the other photoconductor. Specifically, the pitch error is caused by shape errors or installation errors of optical elements provided beyond the light flux dividing unit (light flux dividing element).

In order to solve this problem, a pitch adjusting unit for adjusting the pitch in the sub scanning direction needs to be provided between the light flux dividing unit and the deflecting unit.

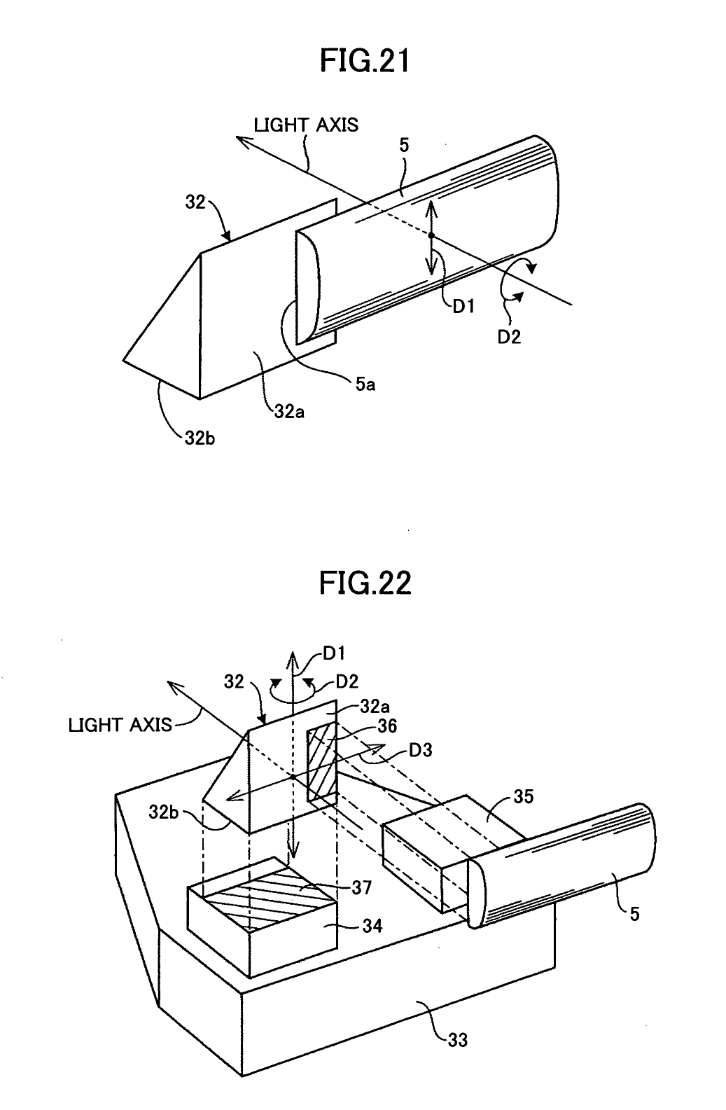

An example of the pitch adjusting unit is shown in FIGS. 21, 22. The cylindrical lens 5 is attached to a housing 33 of the optical scanner via a middle member 32. The middle member 32 is triangular, and includes a planar part 32a that contacts the cylindrical lens 5 and a planar part 32b that contacts the housing 33, which planar part 32b is orthogonal to the planar part 32a.

One end of the cylindrical lens 5 in the longitudinal direction is fixed to the middle member 32 in a cantilevered manner. Before being fixed to the middle member 32, the position of cylindrical lens 5 can be adjusted with respect to the planar part 32a of the middle member 32 in the sub scanning direction (indicated by arrow D1), and in the eccentric direction (indicated by arrow D2) around the axis parallel to the light axis.

In other words, as the middle member 32 includes the planar part 32a that is a planar surface orthogonal to the light axis of the cylindrical lens 5, the position of cylindrical lens 5 can be adjusted in the eccentric direction around the light axis and in the direction orthogonal to the light axis.

As shown in FIG. 22, the position of the middle member 32 can be adjusted before being fixed to the top surface of a protruding part 34 of the housing 33. Specifically, the position of the middle member 32 can be adjusted in the direction of the light axis, the direction in a main scanning direction (indicated by an arrow D3), and the direction around an axis parallel to the sub scanning direction (indicated by an arrow D4). The middle member 32 is made of a transparent material (for example, plastic).

Therefore, the position of the cylindrical lens 5 can be adjusted in plural directions with respect to the middle member 32, and the position of the middle member 32 can be adjusted in plural directions with respect to the housing 33.

Further, at least one adjustable direction of the position of the middle member 32 with respect to the housing 33 is different from at least one adjustable direction of the position of the cylindrical lens 5 with respect to the middle member 32.

With the above-described configuration, improving a plurality of optical properties (wider beam waist diameter, reduced shifts in beam waist positions, and reduced shifts in beam spot positions) can be achieved at the same time. Further, by making it possible to adjust the position of the cylindrical lens 5 in the eccentric direction around an axis parallel to the light axis, the scanning intervals can be optimally set in the sub scanning direction.

In FIG. 22, reference numerals 36 and 37 denote surfaces for applying an adhesive (fixing surface or adhering surface).

The actual adjusting method is described with reference to FIG. 22. The cylindrical lens 5 is supported by a not shown jig, and the cylindrical lens 5 is shifted in a direction of adjustment (in this example, the light axis direction, eccentric direction around axis parallel to the light axis, and sub scanning direction).

The middle member 32 whose surface 36 is supplied with ultraviolet cured resin is pressed against a planar part 5a of the cylindrical lens 5, and against the surface 37 of the housing 33 supplied with ultraviolet cured resin (temporary fixing). Ultraviolet rays are emitted so as to fix the cylindrical lens 5 and the middle member 32.

The middle member 32 is made of a transparent material, and therefore, the degree of freedom in emitting ultraviolet rays can be enhanced, so that the operation of emitting ultraviolet rays is facilitated. Accordingly, the cylindrical lens 5 and the middle member 32 can be fixed quickly without unfixed areas remaining.

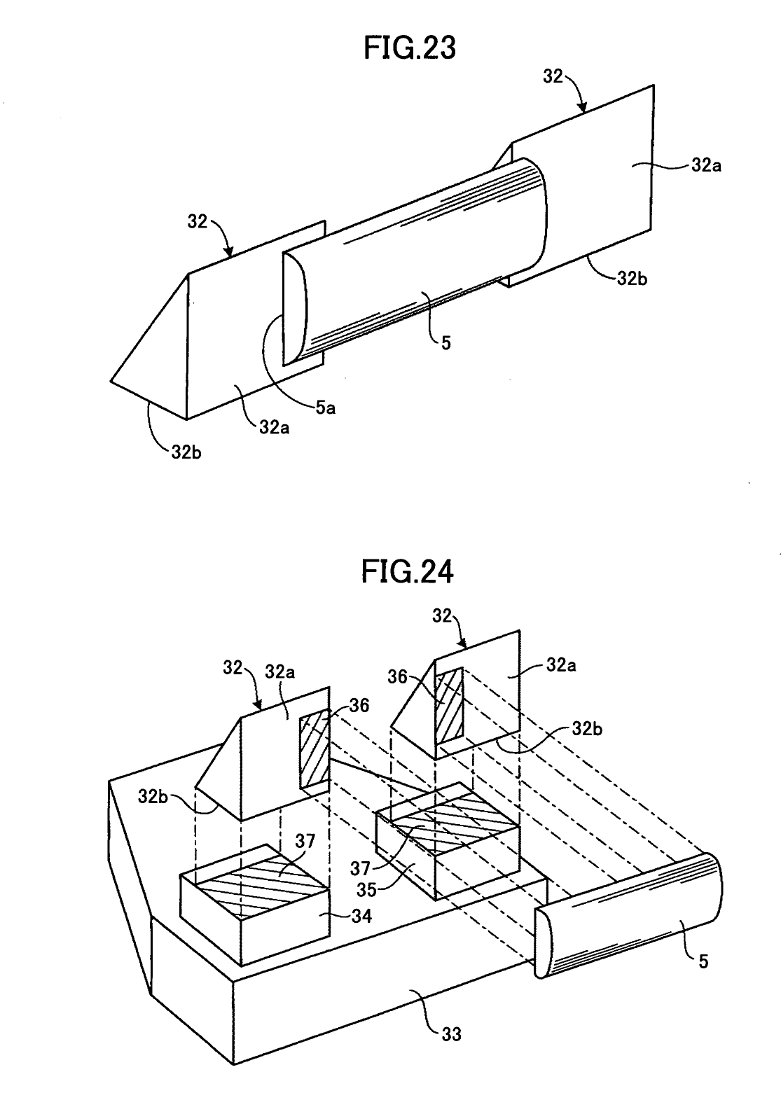

In the above example, the cylindrical lens 5 is fixed to one middle member 32 in a cantilevered manner. However, the cylindrical lens 5 can be fixed to a plurality of middle members 32. An example is described with reference to FIGS. 23, 24.

As shown in FIG. 23, two middle members 32 are disposed on opposite sides of a light beam passing through the cylindrical lens 5. In other words, among a main scanning direction and a sub scanning direction of the cylindrical lens 5, the two middle members 32 are spaced apart in a direction parallel to the longer side of the cylindrical lens 5 (in this case, the sub scanning direction). The cylindrical lens 5 is fixed to each of the planar parts 32a of the two middle members 32.

One of the middle members 32 is fixed onto the upper surface of the protruding part 34 of the housing 33, and the other middle member 32 is fixed onto an upper surface of another protruding part 35 of the housing 33.

The fixing is performed by a method similar to the above. Specifically, after positioning the cylindrical lens 5, and pressing it against the middle members 32, ultraviolet rays are emitted.

The following advantages can be achieved with this fixing (supporting) configuration. For example, even if the temperature rises when the housing 33 and the middle members (made of synthetic resin) 32 have different linear expansion coefficients, stress is generated at the symmetric position of the optical element (cylindrical lens 5) with respect to the light axis. Accordingly, the posture of the optical element can be prevented from changing due to changes in the temperature.

Between a main scanning direction and a sub scanning direction of the cylindrical lens 5, the two middle members 32 are spaced apart in the direction parallel to the longer side of the cylindrical lens 5. With this configuration, an allowable range of positional errors can be made wider, so that eccentric errors can be reduced.

In the above embodiments, two light beams scan one photoconductor. Instead, a photoconductor can be scanned by one light beam.

The present invention is not limited to the specifically disclosed embodiment, and variations and modifications may be made without departing from the scope of the present invention.

The present application is based on Japanese Priority Patent Application No. 2005-262365, filed on Sep. 9, 2005, the entire contents of which are hereby incorporated by reference.

What is claimed is:

1. An optical scanner comprising:
a light source configured to emit a light beam;
a deflecting unit configured to deflect and scan the light beam emitted from the light source;
a scanning optical system configured to focus the light beam deflected and scanned by the deflecting unit onto a plurality of different surfaces to be scanned; and
a light quantity correcting unit configured to correct a light quantity of the light beam emitted from the light source; wherein
the light quantity correcting unit changes light quantity correction data used for correcting the light quantity of the light beam emitted from the light source for each of the different surfaces to be scanned, the light quantity correction data being dependent on positions in a main scanning direction.

2. An optical scanner comprising:
a light source configured to emit a light beam;
a deflecting unit configured to deflect and scan the light beam emitted from the light source;
a scanning optical system configured to focus the light beam deflected and scanned by the deflecting unit onto a plurality of different surfaces to be scanned; and
a beam spot position correcting unit configured to correct beam spot positions in a main scanning direction on each of the different surfaces to be scanned; wherein
the beam spot position correcting unit changes position correction data used for correcting the beam spot positions for each of the different surfaces to be scanned.

3. The optical scanner according to claim 1, further comprising:
a light flux dividing unit configured to divide the light beam emitted from the light source into a plurality of the light beams, wherein
the deflecting unit includes polygon mirrors disposed in plural levels and a rotational axis common to the polygon mirrors, the polygon mirrors being shifted from each other so as to be at different angles in a rotational direction, and
each of the light beams divided from the light source is guided to one of the polygon mirrors, so that each of the light beams scans one of the different surfaces to be scanned.

4. The optical scanner according to claim 2, wherein
the beam spot position correcting unit corrects an image write start timing, and
the position correction data are used to control the image write start timing.

5. The optical scanner according to claim 2, wherein
the beam spot position correcting unit corrects a frequency of a clock that drives the light source, and
the position correction data are used to control the frequency of the clock.

6. The optical scanner according to claim 2, wherein
the beam spot position correcting unit corrects unevenness of intervals between beam spot positions on each of the surfaces to be scanned, and
the position correction data are used to control the unevenness of the intervals between the beam spot positions.

7. The optical scanner according to claim 6, wherein
the beam spot position correcting unit corrects the unevenness by shifting a phase of a pixel clock.

8. The optical scanner according to claim 6, wherein
the beam spot position correcting unit corrects the unevenness by modulating a frequency of a pixel clock.

9. The optical scanner according to claim 2, wherein
the beam spot position correcting unit divides a scan area on each of the surfaces to be scanned into a plurality of sections, and corrects the beam spot positions by each section.

10. The optical scanner according to claim 1, wherein
the light quantity correcting unit divides a scan area on each of the surfaces to be scanned into a plurality of sections, and corrects the light quantity by each section.

11. The optical scanner according to claim 1, further comprising:
a memory unit configured to hold the light quantity correction data.

12. The optical scanner according to claim 2, further comprising:
a memory unit configured to hold the position correction data.

13. The optical scanner according to claim 1, further comprising:
a light detecting unit configured to recognize a beam spot position by detecting a signal; wherein
image forming for a main scanning line starts in response to the light detecting unit detecting the signal, and
the light quantity correcting unit changes the light quantity correction data after the image forming for the main scanning line is completed and before the light detecting unit detects a next signal.

14. The optical scanner according to claim 2, further comprising:
a light detecting unit configured to recognize a beam spot position by detecting a signal; wherein
image forming for a main scanning line starts in response to the light detecting unit detecting the signal, and
the beam spot position correcting unit changes the position correction data after the image forming for the main scanning line is completed and before the light detecting unit detects a next signal.

15. The optical scanner according to claim 1, wherein
the light quantity correction data represent a difference between a preset standard value.

16. The optical scanner according to claim 2, wherein
the position correction data represent a difference between a preset standard value.

17. The optical scanner according to claim 3, wherein
the light flux dividing unit includes a half mirror and a reflection surface.

18. An image forming apparatus comprising:
the optical scanner according to claim 1 configured to form an electrostatic latent image on an image carrier;
a developing unit configured to form a visible image based on the electrostatic latent image formed on the image carrier by using color toner; and
a transfer unit configured to transfer the visible image on the image carrier to a recording medium, to output a full-color image.

19. An image forming apparatus comprising:
the optical scanner according to claim 2 configured to form an electrostatic latent image on an image carrier;
a developing unit configured to form a visible image based on the electrostatic latent image formed on the image carrier by using color toner; and
a transfer unit configured to transfer the visible image on the image carrier to a recording medium, to output a full-color image.
